(19) United States
(12) Patent Application Publication
(10) Pub. No.: US 2005/0091124 A1
(43) Pub. Date: Apr. 28, 2005

(54) Product purchase decision making and information device

(76) Inventor: Phillip A. White, Pittsburgh, PA (US)

Correspondence Address: BUCHANAN INGERSOLL, P.C., ONE OXFORD CENTRE, 301 GRANT STREET, 20TH FLOOR, PITTSBURGH, PA, 15219, US

(21) Appl. No.: 10/980,101

(22) Filed: Nov. 1, 2004

Related U.S. Application Data
(63) Continuation of application No. 09/717,881, filed on Nov. 21, 2000.
(60) Provisional application No. 60/167,167, filed on Nov. 23, 1999.

(51) Int. Cl. G06F 17/60

(52) U.S. Cl. 705/26

(57) ABSTRACT

A product purchase decision making device for assisting consumers in making purchase decisions. Data identifying the product is inputted into the handheld device, either by the consumer directly or by scanning the products' bar code label. The device accesses a global telecommunication network to retrieve information concerning that product from an information database, such as the manufacturers' website or a consumer reporting agency. A decision is automatically displayed to the consumer by a series of decision buttons, indicating a “yes” or “no” decision, or a “caution” decision advising the consumer to research additional information. The additional information may be automatically displayed on the device's display screen. The device comprises a handheld computer, personal data assistant or a cellular telephone.

### RELATED APPLICATION

This application is related to provisional patent application Ser. No. 60/167,167, filed on Nov. 23, 1999.

### BACKGROUND OF THE INVENTION

1. Technical Field

The present invention relates to a hand-held computing device, and more particularly to a personal digital assistant (PDA) device which can obtain product information over a global telecommunication network to make product purchase decisions.

2 Prior Art

The state of the art of computer technology has evolved to the point where vital components necessary for the operation of a digital computer, such as memory modules, integrated circuits and power sources are becoming smaller and more lightweight. In addition, data input means may comprise an electronic pen such that space normally needed for information input such as keyboards and the like are unnecessary. This has also enabled the use of liquid crystal display (LCD) screens which can also operate as “touch screens” for the direct input of information into the device. These devices are commonly referred to as hand-held computers, palm-size computers or personal digital assistants (PDA). These devices also have the ability for wireless communication via satellite to a global telecommunication network such as the internet and can provide the user with access to a plurality of information sources. As such, these functions can be incorporated into a cellular phone.

While these evolutions in computer and telecommunication technology allow users to obtain information from a vast variety of sources, it is still required for the user to specifically search for and obtain specific information on products that the person desires to purchase. Often these purchasing decisions can be complex and confusing, in that the person is trying to decide between various options for standard equipment such as things like home appliances, electronics or even groceries, as well as reviewing product safety information which is provided by organizations such as the Consumer Product Safety Commission and/or publications such as Consumer Reports. Industry and trade publications are also available as a source of comparative product information. Some organizations and manufacturers also operate websites on the internet as a digital source of product information. Again while this information is available from a variety of sources, it is still necessary for the individual to physically obtain and review the published material either by purchasing a magazine from a newsstand or store or by logging on to the manufacturer's dedicated website on the internet to review this product information. Then the purchaser must often visit a number of stores to determine which store has not only the best price but offers the particular product with the various options and components that the consumer desires to purchase.

At present, PDAs, hand-held computers or palm-size computers use Windows CE or Palm OS as their operating systems. To connect with the internet PDAs, hand-held computers or palm-size computers use mobile channels that let users subscribe to supported web-sites, and then when they synchronize with a desktop computer the latest version of the webpages are downloaded to the PDA, hand-held computer or palm size computer. In addition to synchronizing with a desk top computer or PC, PDAs can also use handwriting recognition for data and text entries. Some of these products also provide text documents or spreadsheets in order to coordinate information input and retrieval for the owner of the device. For cellular telephones, users can input information using the letters on the numerical keypad for dialing the phone.

Often at the retail outlets or other locations where products are purchased, labels are provided which are commonly referred to as barcodes. These are digital representations of a product number such as a serial number or a SKU inventory number, which is used to identify the product that is being offered for sale as well as all the features that are being sold with that product. These barcodes are easily readable by a digital barcode scanner which can then access information about that product, but these barcodes provide no real information to the ultimate product purchaser.

It is therefore an object of the present invention to provide a hand-held device which also has barcode scanning and reading capabilities which can then provide information with respect to that particular product to the owner of the hand-held device. Preferably a palm-size computer or PDA also has a means for wireless access to information about that product over the global telecommunications network such as by satellite links and the like. The wireless access maybe provided by a separate device or can be constructed as an integrated device by incorporating these features into a cellular phone. In a preferred embodiment the device will also obtain information related to the reliability of operation and safety features, product quality or potential risks, side effects and product ingredients of that product and provide an indication to the owner of the device in order to allow that person to make an informed purchasing decision.

A further object of the present invention to provide a decision making device which will automatically tell the user of the device whether or not the purchase of that product is a good decision, a bad decision or one that requires review of further information.

It is still a further object of the present invention to automatically provide the further information to the user in the event that the device provides a cautionary warning to the owner that more information is necessary to make an informed purchasing decision.

### BRIEF DESCRIPTION OF THE DRAWINGS

FIG. 1 shows a hand-held computing device, such as a PDA, having a information display screen and barcode scanning system which also includes a notification system for automatically providing a product purchase decision; and

FIG. 2 shows a cellular phone having the product purchase functions of the present invention.

### SUMMARY OF THE INVENTION

The present invention provides a unique product improvement to a PDA or palm size hand-held computer that lets users organize personal information. The system provides a product approval rating system primarily through the UPC/barcode or other technology used for identifying products. An approval light code system preferably comprises green (“approved”), yellow (“caution”) and red (“disapproved”). Preferably each of these light codes are also in a particular shape to signify which of the buttons have been illuminated such as a circular green sign, a triangular yellow yield sign, or an octagonal red stop sign. In addition, the buttons can have wording which is also illuminated such as “YES” for green, “MAYBE” in yellow and “NO” in red. In another preferred embodiment, these functions are incorporated into a cellular phone for direct wireless access to the internet.

### DESCRIPTION OF THE PREFERRED EMBODIMENT

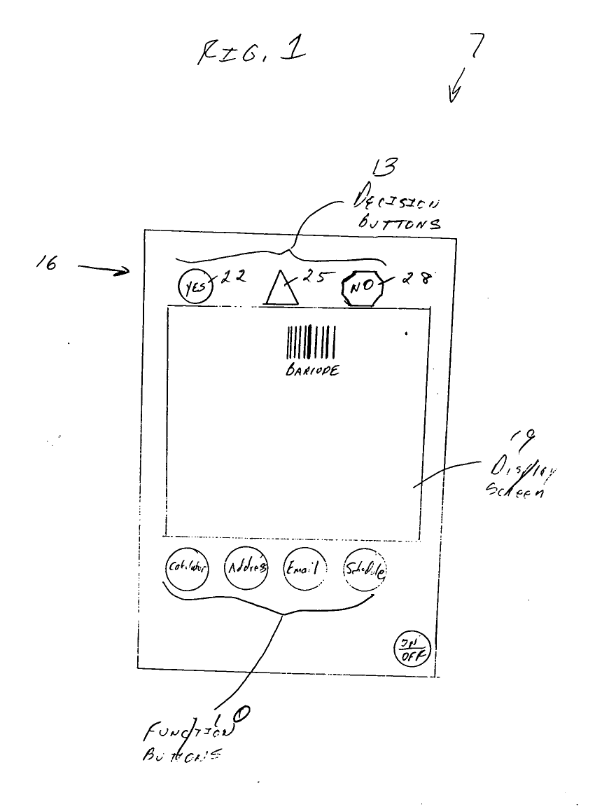

Referring now to FIG. 1 in detail, there is shown therein a conventional palm-size computer or PDA 7 having typical function buttons 10, which has been improved by providing the product decision making buttons or indicators 13 of the present invention directly thereon. In the embodiment shown in FIG. 1, a top portion 16 of the device above the display screen provides 19 color-coded buttons 13, such as green 22 for a positive response, red 25 for a negative response or yellow 28 for a precautionary response telling the user to obtain further information. The LCD or liquid crystal display 19 also provides a means for displaying the additional information in the event that the yellow or precautionary response is received, wherein additional information about the product can be retrieved by the owner of the device 7. Information may also be provided to the consumer when a positive or negative purchasing decision is made. For example, information concerning the desirable features of a product can be given when a positive decision is made, as well as the negative reasons giving rise to a do not buy a decision.

As is common with many PDA's or hand-held computers 7, the LCD display 19 also provides a means for inputting information such as with a light pen or by directly scanning barcodes 31 as shown in FIG. 1. When a person desires to obtain information about a particular product the PDA 7 is used to scan the barcode which is typically provided in close proximity to the product, such as on the product carton or on the shelf at the retail outlet where consumers typically purchase products. When the barcode 31 has been scanned the PDA 7 will immediately recognize which product is being investigated and will send a wireless signal over the global telecommunications network or the internet to obtain information about that product. The information that is obtained will then be transmitted back to the PDA over the global telecommunications network and will provide an indication to the memory or circuitry of the PDA as to whether or not the purchase of that product is recommended by activating the appropriate decision button 13.

As shown in FIG. 1 three (3) different buttons 19 are provided on the PDA, preferably along the top of the device as shown, but could also be located anywhere on the front surface of the device for easy viewing by the user. Each button provides a unique indication as to the approval or disapproval of the purchase of that product. For example, a circular button 22 which also is color coded green may be used to designate a positive decision, a red octagonal button 25, similar to an ordinary traffic stop sign, may be used to denote a negative decision, while a yellow triangular button 28 is used to denote a cautionary response, recommending the user to obtain more information about that product. Most preferably the color coded buttons are similar to those common with ordinary traffic lights: green denotes “buy” (go), yellow denotes “caution” (yield) and red denotes “do not buy” (stop).

In an alternate embodiment, rather than providing a series of separate buttons which light up on the face of the device, the display 19 can be programmed such that the product purchase decision is displayed directly on the LCD of the PDA. In this way, a red flashing light can denote no, a green flashing light can denote okay or yes, and a yellow flashing light can denote yield or maybe.

In another embodiment of the present invention, a unique sound is provided for each of these indications. For example, a pleasant sound similar to the ringing of a bell can denote a yes for the purchase of the product, an annoying buzzer sound can be used to denote no or stop, and a neutral common beep sound, distinct from the pleasant ringing sound of the yes decision, can be used to designate to the user when more information is to be reviewed. Alternatively, the device may be programmed to vibrate to indicate a negative response.

As previously stated, when a yellow indication 28 is provided the PDA 7 will also automatically provide in the LCD display window 19 more information which is then used by the owner of the PDA in order to make the purchasing decision. Since a database of information about numerous products already exists, the device 7 has the ability to obtain this information through wireless communication over the global telecommunication network because of the unique bar coding system which is provided for manufacturers products.

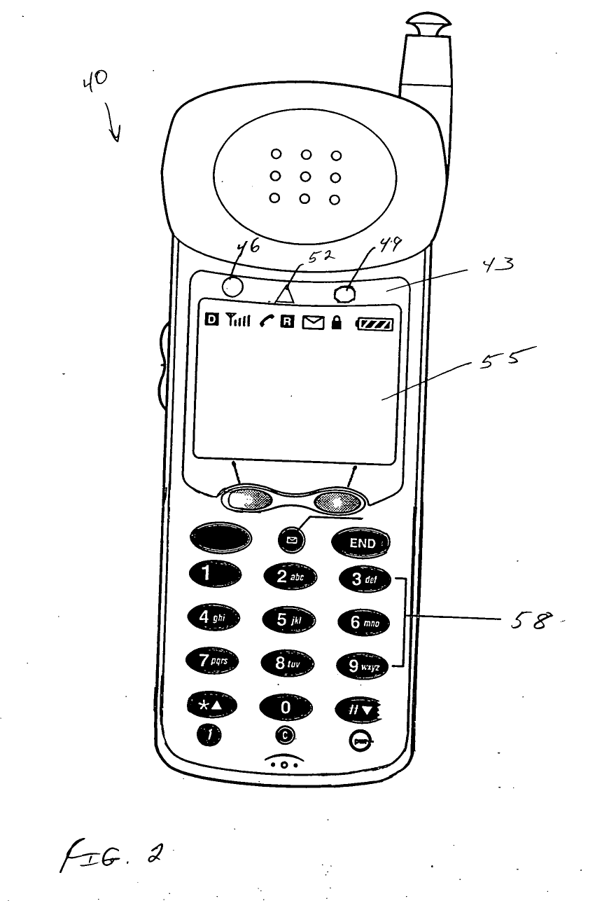

An alternative embodiment of the present invention is shown in FIG. 2. In this embodiment a cellular phone 40 incorporating the functionality of the product purchase decision making device are incorporated therein. This device 40 can provide direct wireless access to the internet without having to separately subscribe to internet access with a PDA. The phone 40 has been modified to include decision making buttons 43. As before, the buttons 43 preferably include a circular “yes” button 46, an octagonal “no” button 49 and a triangular “maybe” button 52. Additionally, each of these buttons can be color-coded green, red and yellow, respectively. Additional information to be provided to aid the consumer can be outputted on the display screen 55. If the consumer needs to ask questions or input information, the phone is alphanumeric keyboard 58 can be used. The cellular phone device 40 may also include a bar code scanner (not shown), as well as incorporating other well-known features of cellular phones and/or PDA's.

In order to make a product purchasing decision, the user of the device preferably follows the following steps:

The device's barcode scanner is used to scan the barcode on the shelf or directly from the product label. In the event that the PDA does not include the barcode scanner integral therewith, the PDA or cellular phone keyboard can also be used to manually enter the numbers associated with that digital barcode. The PDA is then instructed to obtain information over the global telecommunications network related to that particular product. By the use of satellite and other wireless telecommunication linking system, the product information is quickly obtained from the vast resources available over the communication network such as the internet, and a product approval or disapproval rating can automatically be given. For example, if it has been determined through product testing that a particular product is either unreliable in its operation or has been determined by a testing organization to be an unsafe product, a “no” or red light indication is immediately received on the device. However, if the product has been recommended as one that is a good value for the consumer and is recommended to be purchased a “yes” or green light indication is immediately given to the owner. In the event that there are either similar products that need to be evaluated in order for the purchaser to make an informed decision or if there are certain features or information about the device that a salesperson at the retail outlet can provide, a “caution” or yellow response is immediately received and displayed by the device. If additional purchasing information is automatically available over the global telecommunication network, that information can be displayed and read from the devices display screen while the consumer is still at the sales center, or the user can be given instructions as to what questions to ask the salesperson in making the product purchase decision. The device may also direct the user to the additional sources of information.

Since the information can be stored in the PDA, the PDA can be later connected to the persons desktop personal computer in order to either print out that information or to provide as a further means for linking to sources of the information identified through the PDA. Moreover, the stored information cam be used as a source of product information for further review.

Thus the present invention provides a unique product purchase decision making device in that the user can immediately know whether or not the purchase of a particular product is a good or bad decision, since the device can access a multitude of information sources that can be automatically consulted through the product decision making device in making a product purchase decision. One of the cautionary items that may be displayed, for example, may be that, while the product itself is a good purchasing decision, the information may be available that the particular product can be purchased for a lower price or with better options from a different source, either a different detail outlet, catalog or via the internet. Thus a cautionary response could be provided for the product but the additional information in the LCD tells the user to either negotiate a better price, better options or instruct the user to shop at a different retail outlet. Retailers may also provide UPC/Barcode information in their print advertisements, thus making it easier for consumers to shop at home.

In addition further product information can be provided when a cautionary response is received. For example, information on operation reliability, product recalls and safety features or risks about a particular product can automatically be provided to the user. In this way, a person can access the known safety risks or potential side effects of a particular product at the point of purchase.

This device is also usable for service providers, as well. For example, in a restaurant setting a customer can obtain nutritional information on health conscious menu items, such as calorie and vitamin information of prepared meals. Information concerning the operation of the facility such as local health code ratings and/or restaurant reviews may also be accessed. While food product labeling requirements are such that the ingredients are to be identified on food product packaging, that is not necessarily the case for prepared foods. Consumers can be provided this information by scanning menu items using the product decision-making device of the present invention. Moreover, the health and safety benefits and risks of certain food additives, such as monosodium glotamate (MSG), BHT and BHA and the like, which can not only be identified as being present in those foods but the amount and health effect of this ingredient can be identified and published by the Food and Drug Administration (FDA) and can be instantly transmitted to the consumer.

Another potential use for this device is for a two-way communication means for providing input back to the product supplier. In the food product example, a consumer can send a message, such as by e-mail to the product manufacturer or supplier, indicating what the consumer's concerns and needs are with regard to the ingredients and components of a particular product.

While specific embodiments of the invention have been described in detail, it would be appreciated by those skilled in the art that various modification and alternations would be developed in light of the overall teachings of the disclosure. Accordingly, the arrangements disclosed are meant to be illustrative only and not limiting as to the scope of the invention which is to be giving the full breadth of the appended claims and in any and all equivalents thereof.

1. A product purchase decision making device comprising:
means for inputting product identification information;
means for accessing a plurality of product information sources;
means for receiving product information based on said product identification information from said plurality of product information sources, including product safety information; and
means for indicating to a user a product purchase decision based on said received product safety information.

2. The device as recited in claim 1, wherein said indicating means comprises:
a green positive indicating button;
a red negative indicating button; and
a yellow caution indicating button.

3. The device as recited in claim 1, wherein said indicating means comprises:
a circular positive indicating button;
an octagonal negative indicating button; and
a triangular caution indicating button.

4. (canceled)

5. The device as recited in claim 1, further comprising means for displaying received product information.

6. The device as recited in claim 1, wherein the device comprises one of a personal digital assistant, laptop computer, handheld computer, palmtop computer or a cellular phone.

7. The device as recited in claim 1, wherein said means for inputting product identification information comprises a bar code scanner.

8. The device as recited in claim 1, wherein said means for inputting product identification information comprises an alphanumeric keyboard.

9. The device as recited in claim 7, wherein said indicating means comprises:
a green positive indicating button; a red negative indicating button; and a yellow caution indicating button.

10. The device as recited in claim 7, wherein said indicating means comprises:
a circular positive indicating button; an octagonal negative indicating button; and
a triangular caution indicating button.

11. (canceled)

12. The device as recited in claim 8, wherein said indicating means comprises:
a green positive indicating button; a red negative indicating button; and a yellow caution indicating button.

13. The device as recited in claim 8, wherein said indicating means comprises:
a circular positive indicating button; an octagonal negative indicating button; and
a triangular caution indicating button.

14. (canceled)

15. The device as recited in claim 1, further including means for providing input information to a product manufacturer.

16. The device as recited in claim 1, wherein said indicating means comprises:
a green positive indicating button; and
a red negative indicating button.

17. The device as recited in claim 7, wherein said indicating means comprises a positive indicating button and a negative indicating button.

18. A food product purchase decision making device comprising:
means for inputting food product identification information;
means for accessing a food product information source;
means for receiving food product information based on said product identification information from said food product information source, including nutritional information regarding the food product; and
means for indicating to a user a food product purchase decision based on said food product nutritional information.

19. The device as recited in claim 18, wherein said indicating means comprises:
a green positive indicating button; and
a red negative indicating button.

20. The device as recited in claim 18, wherein said indicating means comprises:
a circular positive indicating button; and
an octagonal negative indicating button.

21. The device as recited in claim 18, wherein said indicating means comprises a positive indicating button and a negative indicating button.

22. The device as recited in claim 18, wherein said nutritional information includes nutritional facts and ingredients for food products available at one or more of a restaurant, a grocery store or a convenience store.

23. The device as recited in claim 18, wherein the food product includes prepared food products and unprepared food products.

24. A product purchase decision making device comprising:
means for inputting product identification information;
means for accessing a plurality of product information sources;
means for receiving product information based on said product identification information from said plurality of product information sources, including product pricing information; and
means for indicating to a user a product purchase decision based on said received product pricing information.
